(19) United States
(12) Patent Application Publication
(10) Pub. No.: US 2006/0209740 A1
(43) Pub. Date: Sep. 21, 2006

(54) Method and system for detecting the presence of a moblie terminal

(76) Inventors: Diego Anza Hormigo, Paris (FR); Florent Le Lain, Montrouge (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/564,949

(22) PCT Filed: Jul. 2, 2004
(86) PCT No.: PCT/FR04/01725

§ 371 Date: Jan. 17, 2006

(30) Foreign Application Priority Data
Jul. 17, 2003 (FR) 03/08722

(51) Int. Cl. H04Q 7/00

(52) U.S. Cl. 370/328

(57) ABSTRACT

A method, system, and computer program product for informing an application server whether or not a mobile subscriber is present on a mobile telecommunication network includes a first step for sending a first distinctive signal from the mobile subscriber to the mobile telecommunication network, intended for the mobile subscriber. A second step determines a present or not present binary state according to a reaction of the mobile telecommunication network to the first signal. A third step communicates to the application server the state determined in the second step.

The field of the invention is that of mobile telecommunication networks. In a mobile telecommunication network, such as the cellular networks of the GSM, GPRS, UMTS types, the users are able to travel with a mobile terminal across all the territory covered by a network to which they have subscribed, even covered by other compatible mobile telecommunication networks, this is called roaming, while retaining their ability to communicate with the mobile telecommunication network and, through it, with the outside for services or applications of the telephony type or other data-type applications.

A user may also temporarily leave the coverage of the mobile telecommunication networks, whether his terminal is switched off intentionally or, unintentionally because the battery has run out. In this case, the user no longer has access to the functions of the network and, reciprocally, he cannot be reached by other persons or by applications.

The term “mobile subscriber” used in this text is the term used in the GSM/GPRS/UMTS standards of the 3GPP and refers to a subscription taken out with a mobile operator which provides access to its mobile telecommunication network. This subscription is identified by the International Mobile Subscriber Identity (IMSI) or the Mobile Station Integrated Services Digital Network number (MSISDN). The IMSI is usually stored in a SIM (Subscriber Identity Module) card which, inside the mobile terminal, links the operation thereof to the identified subscription. The MSISDN does not have to be stored in the SIM card to identify the subscription; the latter may be identified based on a match between MSISDN and IMSI in the core network. The term “mobile subscriber” indicates not so much the person who uses the mobile telecommunication network as the usage that the person makes thereof or is capable of making thereof by means of his mobile terminal.

A binary state of presence of a subscriber on the mobile network is defined as follows. A mobile subscriber is present on the network when he has access to the functions of the latter and consequently can be reached by external applications (voice services, data services). Conversely, the mobile subscriber is not present, that is to say absent from the network, when he does not have access to these functions and cannot be reached by external applications. This second state corresponds, for example, to the mobile terminal being switched off or to the mobile terminal being on a part of territory not covered by the mobile telecommunication network.

In general, the context or information of presence of a mobile subscriber is used to describe a data set associated with the subscriber which changes according to the interactions of the latter and/or of his terminal with the network and the external applications. This set may comprise, as a nonlimiting example, at least the state of presence with two values (present, not present) as previously described, the means of reaching the mobile subscriber such as his current IP address, the current activity of the subscriber (mobile on standby, in communication, in WAP session on an X application, etc), the location of the subscriber, etc.

The mechanisms for managing mobility that exist in the mobile networks generate many presence information items. Unfortunately, the latter form part of the internal operation of the network and the applications external to the network do not have access thereto directly in the current state of the art.

Such external applications can therefore not in principle know the state of presence of a given mobile terminal.

The applications that use, in their service logic, the management of the presence of the users, particularly interpersonal communication services, putting in touch or other services, use in the prior art a detection of the presence called applicative.

The applicative presence consists of using an explicit action, either of the user, or of a dedicated program or agent on board the mobile terminal, with the application in question so that the latter can apprise itself of the presence of the user and the manner in which he may be reached.

As an example, instantaneous messaging applications require a registration procedure in which the user must enter his name and password to be able to consider him present and reachable in the service.

These actions usually take the form of an interchange of messages on the applicative protocol layers between the mobile terminal and the application server. In this case, the mobile telecommunication network limits itself to conveying the messages sent by the terminal to the applications server.

In a mobile telecommunication environment, the use of the applicative presence has several disadvantages relating to the use of the presence data which may be supplied directly by the mobile telecommunication network.

For example, in the case of deployment, the applicative presence is often based on the use of a specific client on board or downloaded into the mobile terminal. Consequently, the service is limited in this case to the terminal having said client. This is the case for example with a WAP browser or an instantaneous messaging client.

In one case of usage, the applicative presence requires an explicit action in the terminal with respect to the applications server. Mention can be made as an example of the sending of an SMS with a particular content for declaring oneself present, registering on a WAP page, activating the onboard instantaneous messaging client, etc. Frequently, an explicit action of the user is required, composing and sending an SMS, entering a user name and a password on a WAP site, launching the onboard instantaneous messaging client, etc. This represents a very considerable brake on usage which limits the degree of adoption of the service.

To remedy the aforementioned disadvantages of the prior art, an object of the invention is to obtain presence information directly from the mobile telecommunication network. This makes it possible for example to register automatically in a service when the user's mobile telephone is switched on.

An object of the invention is a method for informing an application server whether or not a mobile subscriber is present on a mobile telecommunication network. The method is notable in that it comprises:
at least a first step for sending a first distinctive signal from the mobile subscriber to the mobile telecommunication network, intended for the mobile subscriber;
at least a second step for determining a present or not present binary state according to a reaction of the mobile telecommunication network to said first signal;
at least a third step for communicating to the application server the state determined in the second step.

This method makes it possible to communicate a present or not present state to any application server without first having to have an agent dedicated to this server for the mobile subscriber because it is as a function of a reaction of the mobile telecommunication network to a transmission of a signal that the present or not present state is determined.

The distinctive signal from the mobile subscriber may be of different types.

Particularly, said first signal is a short message sent to the mobile telecommunication network intended for the mobile subscriber. A first transition enabled by a reaction of the mobile telecommunication network indicating that the message is delivered, respectively a second transition enabled by an expiry of a time delay without reaction from the mobile telecommunication network, then activates the second step that determines the present, respectively not present state of the mobile subscriber.

Advantageously, a data coding scheme parameter in a header of the short message is positioned at a value which has the effect of commanding the mobile receiving the message to discard the content of the message and to deactivate a message received indication on the mobile.

Thus, a user of the mobile is not disturbed by the short messages used in the context of the detection of presence.

More particularly, the first step is activated during an activation of the second step by positioning a time delay that is a function of the present or not present state determined in the second step.

Yet more particularly, the method comprises a step of a wait time activated when the second step determines the present state so as to activate the first step after expiry of the wait time.

Alternatively, said first signal consists of a telecommunication network node interrogation of the present or not present state of the mobile subscriber. The reaction of the mobile telecommunication network then consists of a response of the telecommunication network node on the present or not present state of the mobile subscriber.

Again alternatively, said first signal consists of a positioning of a detection point on a telecommunication network node relating to any modification of the present or not present state of the mobile subscriber. The reaction of the mobile telecommunication network then consists of a notification of the telecommunication network node relating to each modification of the present or not present state of the mobile subscriber.

The application server may be permanently informed of the state by subscription or only in the case of need by request.

For a subscription, an activation of the third step communicating the present state to the application server is followed by an activation of the third step communicating the not present state to the application server when the state determined in the second step passes from present to not present.

To respond to a specific need, an activation of the third step results from a transition enabled by a request originating from the server to request the state of the mobile subscriber.

A further object of the invention is a system for informing an application server whether or not a mobile subscriber is present on a mobile telecommunication network. The system is notable in that it comprises:
first means for sending a first distinctive signal from the mobile subscriber to the mobile telecommunication network, intended for the mobile subscriber;
second means for determining a present or not present binary state according to a reaction of the mobile telecommunication network to said first signal;
third means for communicating to the application server the state determined by the second means.

Particularly, the first means are arranged to send the first signal in the form of a short message intended for the mobile subscriber, the second means are arranged to determine the present state when the short message is delivered and to determine the not present state when the short message is not delivered after expiry of a preset time delay.

More particularly, the first means are arranged to send said first signal at regular time intervals that depend on the present or not present state of the mobile subscriber.

The invention will be better understood in the light of the embodiment described now with reference to the appended drawings in which:

FIG. 1 is a diagram of a conventional mobile telecommunication network;

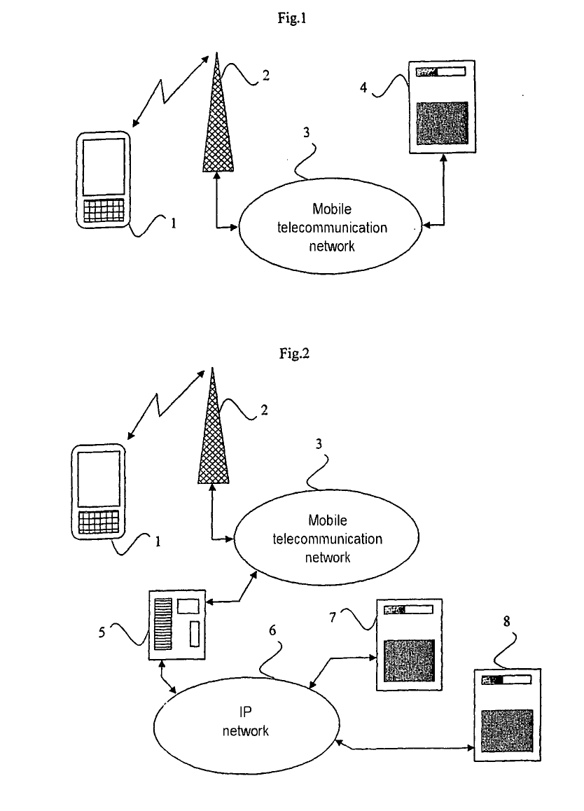

FIG. 2 shows the mobile telecommunication network of FIG. 1 with use of the invention;

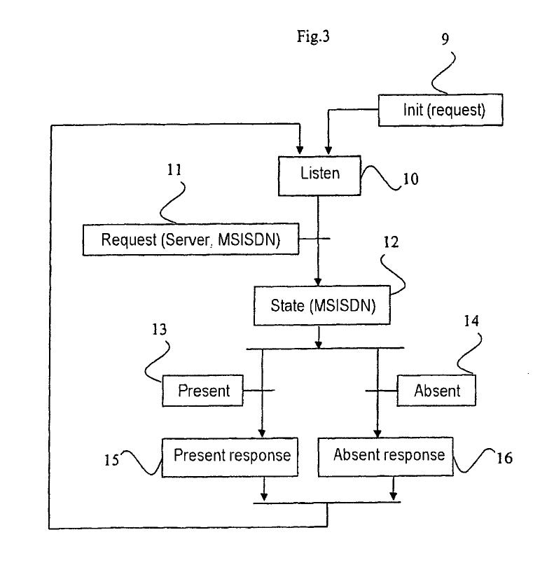

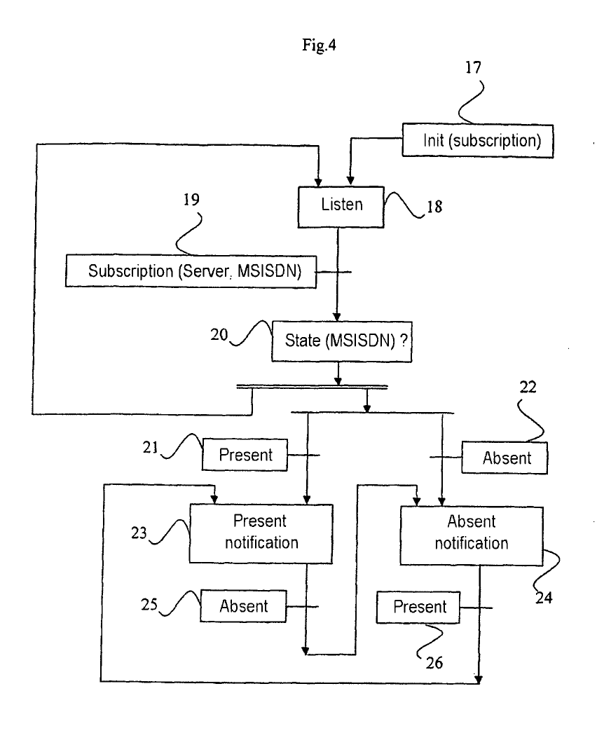

FIGS. 3 to 5 show steps of the method according to the invention.

Conventionally, with reference to FIG. 1, a communicating mobile device 1 communicates with a mobile telecommunication network 3 by interchanging high frequency signals with radio relays 2 connected to the mobile telecommunication network 3 via an access network infrastructure. An application server 4 is connected to the mobile telecommunication network 3 via a core network infrastructure. The application server 4 hosts applications of the electronic messaging or other type, for which the communicating mobile devices 1 host a corresponding agent. An agent corresponding to an application hosted in the application server 4 is a part of an applicative program which, from the communicating mobile device 1, interchanges directly with the application hosted in the application server 4 by passing via the radio relay 2 and the mobile telecommunication network 3. For example, when the communicating mobile device 1 is in radio touch with the radio relay 2 of the mobile telecommunication network 3, the corresponding agent which is in the communicating mobile device 1 sends a signal to the application server 4 to notify the application hosted therein of its presence.

FIG. 2 shows a communicating mobile device 1, a radio relay 2, and a mobile telecommunication network 3 which are all conventional like those shown in FIG. 1. Application servers 7, 8 host applications for which there is no need for the communicating mobile device 1 to contain a corresponding agent. A system of presence detection 5 is connected, on the one hand, to the mobile telecommunication network 3 and, on the other hand, to an IP-type network 6. The network 6 connected to the server 7, 8 allows the system 5 to communicate with these application servers.

The system 5 interfaces with the mobile telecommunication network 3 to obtain presence information from the mobile subscribers via particular means that will be described in the rest of this description. Interfaced with the application servers by means of standard protocols on the IP network, the system 5 processes requests from the various application servers in a centralized manner in order to deliver thereto presence information on the mobile subscribers.

The system 5 may also perform other functions such as that of putting in place techniques for optimizing access to the mobile telecommunication network by means of cache memory, carrying out authorization checks, issuing billing tickets. The application servers 7, 8 use presence information that they obtain from the presence detection system 5 to deliver various services to the communicating mobile device 1.

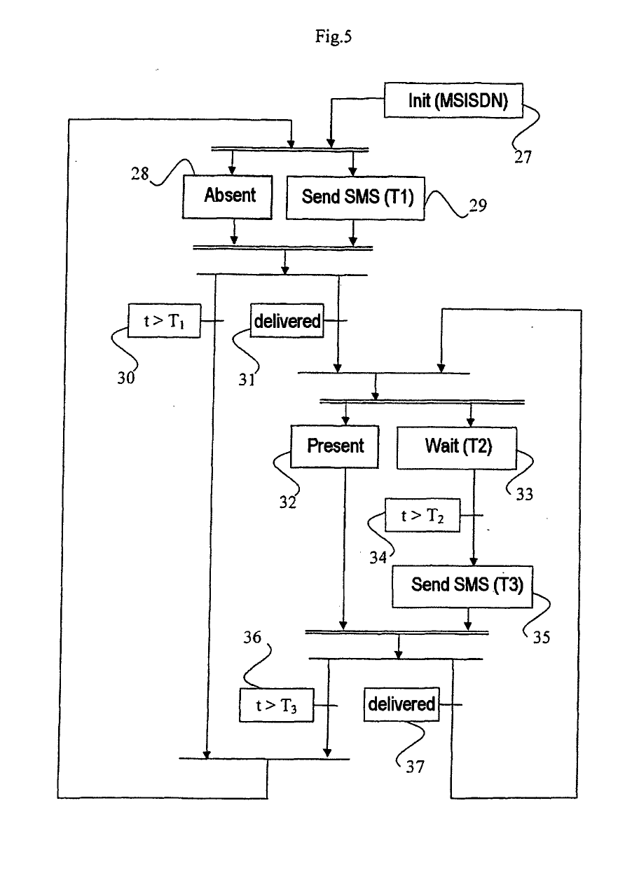

The presence detection system 5 is capable of managing at least two types of interchange with the application servers 7, 8 by implementing for each the method currently described with reference to FIGS. 3 and 4.

The dedicated protocol used for implementing the method is outside the scope of this invention. It may be of a proprietary type or be based on existing standard protocols such as XMPP, SIP/SIMPLE, etc. FIG. 3 shows presence detection method steps executed in the system 5 to respond to presence requests of a mobile subscriber at a moment t received from an application server 7, 8. A step 9 of initializing in request mode, triggered for example when the system 5 is placed in service, places the system 5 in a listening step 10.

In the step 10, the system 5 is listening on the network 6 for requests received from one of the servers 7, 8.

A transition 11 causes the system 5 to pass from the step 10 to a step 12. The transition 11 is enabled by a receipt of a request received from one of the servers 7, 8 by the network 6. The request that enables the transition 11 is distinctive of the server which sent it and of the mobile terminal number MSISDN for which the server in question requests the state of presence on the mobile communication network 3.

In the step 12, the system 5 consults the state of presence of the MSISDN. Means implemented by the system 5 to obtain the state of presence of the MSISDN are explained later in the description. A present state of the MSISDN enables a transition 13. An absent state of the MSISDN or else not present, enables a transition 14.

A transition enable 13 causes the system 5 to pass from the step 12 to a step 15. In the step 15, the system 5 sends over the network 6 a response to the application server which has sent the request, to inform it of the presence of the mobile subscriber identified by the MSISDN.

In the step 16, the system 5 sends over the network 6 a response to the server which has sent the request to inform it of the absence or non-presence of the mobile subscriber identified by the MSISDN. After the step 15 or the step 16, the system 5 remains in the listening step 10 awaiting a new presence request from a server for the same or another mobile subscriber.

The request sent by the application server may also be non-specific to a given MSISDN but, for example, of the type to request all the MSISDNs in the present state. In this case, the response provides a list of present MSISDNs.

FIG. 4 shows presence detection method steps executed by the system 5 to inform application servers 7, 8 of the state of presence of mobile subscribers permanently in the context of a subscription. An initialization step 17, activated for example when the system 5 is placed in service, places the system 5 in a listening step 18 to operate in subscription mode.

In the step 18, the system 5 is listening for any new subscription received by the network 6, via a man-machine interface (not shown) connected to the system 5 to specify subscriptions of application and mobile subscriber or subscription table consultation servers internal to the system 5.

A transition 19 is enabled by each subscription identified for a determined server and a mobile subscriber identified by an MSISDN.

Each enable of a transition 19 activates a step 20 in which the system 5 consults the state of presence of the mobile subscriber identified by the MSISDN in the context of the subscription having enabled the transition 19.

The system 5 loops back to the listening step 18 for any other subscription.

A present state of the mobile subscriber enables a transition 21. A not present or absent state of the mobile subscriber enables a transition 22.

An enable of the transition 21 activates a step 23 in which the system 5 sends a notification of presence of the mobile subscriber to the server concerned by the subscription.

An enable of the transition 22 activates a step 24 in which the system 5 sends a notification of non-presence or absence to the application server concerned by the subscription.

A new absent state enables a transition 25 and a new present state enables a transition 26.

After the step 23, the transition 25 activates the step 24 and, after the step 24, the transition 26 activates the step 23 so that the server concerned by the subscription is permanently informed of the state of presence of the mobile subscriber.

In the step 23, the system 5 adds, where necessary, to the notification of presence, other mobile subscriber-related contextual data called presence information.

FIG. 5 shows particular steps of the method for obtaining the state of presence of a mobile subscriber so as to be able to execute the steps 12, 20 previously described.

The present embodiment describes a method of detecting the state of presence of a mobile subscriber by sending invisible SMSs applicable in the networks of the GSM/GPRS/UMTS type. Other techniques may be used to extract the presence information from the mobile core networks 3. The technique of the invisible SMSs has the advantage of being very simple to implement and compatible with all the GSM/GPRS/UMTS networks currently deployed. Recommendation TS 123.040 of the 3 GPP, version 5.5.1 of September 2002, defines how to produce a short message service (SMS). More particularly, chapter 9.2.2.1 describes basic types of programming of the headers of SMS messages to act on the message delivery mode. From the transfer protocol TP-MTI to TP-UD parameters of the table shown in chapter 9.2.2.1 of Recommendation TS 123.040, the inventors have selected the TP-data-coding-scheme (TP-DCS) parameter which identifies the coding scheme in the user data of the transfer protocol. The TP-DCS parameter contains eight bits of which the 3GPP Recommendation TS 23.038 defines, in chapter 4, behaviors of delivery of SMS messages according to the values at zero or at one of these eights bits numbered from zero to seven. The inventors have selected, from 3GPP Recommendation TS 23.038 V3.3.0 (2000-01), a positioning of the TP-DCS parameter at the hexadecimal value C0. Thus, the value 1100 of bits 7 to 4 of the TP-DCS parameter has the effect that the mobile discards the contents of the message while presenting at most an indication to the user. The value 0 of bit 3 deactivates the indication to the user. The values of bits 2 to 0 have no particular effect for the invention, since the value at zero of bit 2 is imposed in chapter 4 of the aforementioned Recommendation TS 23.038. The null value of bits 1 and 0 relates to awaiting a voice mail message. It will be understood that any other value of bits 1 and 0 has no effect on the implementation of the invention. The selection of a value of the group of four indication bits so as to trigger a discard of message content and the selection of a value of the indication activation bit so as to deactivate the indication make it possible to generate an invisible SMS as a short message whose headers are programmed in a particular manner so that the receiving mobile terminal immediately acknowledges the receipt of the message and the receiving mobile terminal displays no behavior perceptible by the user.

As known in the GSM/GPRS/UMTS standards, the mobile telecommunications core network 3 comprises a short message service management centre (SMS-C) not shown.

The acknowledgements of receipt for the SMSs form an optional functionality which allows the sender to be notified by the SMS-C when the message has been received by the intended terminal. As will be seen hereinafter, it is possible to use or not use acknowledgements of receipt as defined in chapters 3.2.9 and 9.2.2.3 of the aforementioned 3GPP Recommendation TS 23.040.

An “alert-SC” procedure allows the mobile telecommunication network to inform the SMS-C of the registration in the network of a mobile subscriber who is absent when a short message is sent so that the latter may make a fresh attempt to deliver the waiting messages. This event notification is performed through the MAP-alert-SC message sent by the HLR to the SMS-C (see 3GPP TS 29.002 V3.14.0 2002-09, chapter 12.5). This functionality is exploited by the present invention to detect the registration of a subscriber in the network after a period of absence.

With reference to FIG. 5, the presence detection method uses the sending of invisible SMSs to the subscribers whose presence must be detected. The SMS-C performs the delivery of the SMSs in the GSM/GPRS/UMTS networks and acts as a point of entry to the mobile core network for the presence detection system. The interface and the protocol for dialog between the system 5 and the SMS-C are specific to each operator (UCP and SMPP are the most widely used).

With reference to FIG. 5, an initialization step 27 specific to each MSISDN places the mobile subscriber concerned in an absent state by default defined by a step 28. Each activation of the step 28 simultaneously activates a step 29 in which the system 5 sends an SMS to the mobile subscriber. Preferably, the SMS is of the invisible type as defined hereinabove so as not to disturb the user of the mobile. The SMS indicates in the header that it has a lifetime T₁ after which the SMS is destroyed by the SMS-C if it has not been received by the mobile subscriber. So that the SMS-C can check the reception of the message by the mobile, the SMS message is of the type with acknowledgement of receipt notified to the SMS-C by the mobile.

The step 29, combined with the sending of the short SMS message, starts a time counter t. A transition 30 is enabled when the time t passes the value T₁ without the SMS-C having received an acknowledgement of receipt notified by the mobile. The transition 30 may be enabled in different ways.

According to a first possible way, the time counter resides in the SMS-C. The SMS-C is then configured so as to start the counter of the step 29 on receipt of the SMS message from the system 5 and so as to send an acknowledgement of nondelivery to the system 5 when the time t passes the value T₁ without having received an acknowledgement of receipt notified by the mobile. In the system 5, the transition 30 is then enabled by the acknowledgement of nondelivery received from the SMS-C.

According to a second possible way, the time counter resides in the system 5. The transition 30 is then directly enabled in the system 5 when the time t passes the value T₁. This second way does not require any particular configuration of the SMS-C to enable the transition 30.

A notification of delivery by the SMS-C to the system 5 enables a transition 31.

The enable of one of the transitions 30 or 31 has the effect of stopping the counter of the step 29.

The transition 31 simultaneously activates a step 32 and a step 33.

In the step 32, the mobile subscriber is recognized in a present state by the system 5. In the step 33, the system 5 starts a time counter t to produce a wait time T₂. A transition 34 is enabled when the time t passes T₂.

The transition 34 activates a step 35 in which the system 5 sends an SMS short message with a lifetime T₃. In the step 35, the SMS-C according to the first way, or the system 5 according to the second way previously explained, starts the time counter t so as to enable a transition 36 when the time t passes the time delay T₃.

As for the transitions 30 and 31, an enable of one of the transitions 34, 36 or 37 has the effect of stopping a previous start of any time counter.

A transition 37 following the steps 32 and 35 is enabled when the short message is delivered to the mobile subscriber. An enable of the transition 37 again activates the steps 32 and 33.

An enable of the transition 30 following the steps 28 and 29 or of the transition 36 following the steps 32 and 35 again activates the steps 28 and 29.

To implement the previously described method, the system 5 comprises first means that make it possible to send a signal to the mobile telecommunication network 3. It is, for example, an interface of conventional type between the system 5 and a network node 3. In the example described with reference to FIG. 5 in which the signal is a short message (SMS) sent to the mobile terminal 1, the first means are of the software type arranged to generate short messages with a header programmed so that the short messages are not visible to the operator and trigger a transmission of an acknowledgement of receipt by the mobile terminal to the SMS-C on receipt.

The system 5 comprises second means in software form, as firmware or as a dedicated microcircuit which, executing for example the steps and transitions 27 to 37, determine a present or not present binary state according to a reaction of the mobile telecommunication network 3 to the signal sent by the first means.

When the mobile subscriber is present, the reaction of the network 3 consists of an acknowledgement of receipt forwarded by the SMS-C to the system 5 which, informed that the message has been delivered, enables the transitions 31 and 37 which activate the step 32 corresponding to the present state of the mobile subscriber.

When the mobile subscriber is not present within the expiry time delay of the short message, the reaction of the network 3 is a destruction of the message by the SMS-C. The system 5 receiving no acknowledgement of receipt within the expiry time delay or receiving an acknowledgement of nondelivery, enables the corresponding transition 30 or 36 which activates the step 38 corresponding to the not present state of the mobile subscriber.

When the mobile subscriber is not present on the network 3 but becomes present within the short message expiry time delay T₁, the reaction of the network 3 consists of an acknowledgement of receipt forwarded by the SMS-C to the system 5 which, informed that the message has been delivered, enables the transition 31 which activates the step 32 corresponding to the present state of the mobile subscriber.

When the mobile subscriber is present on the network 3 but ceases to be so within the wait time T₂ before transmission of the short message, the reaction of the network 3 is a destruction of the message by the SMS-C. The system 5, receiving no acknowledgement of receipt within the expiry time delay T₃ or receiving an acknowledgement of nondelivery, enables the transition 36 which activates the step 38 corresponding to the not present state of the mobile subscriber.

In order to limit the traffic between the system 5 and the network 3, the lifetime T₁ of the invisible SMSs sent by the system 5 in the not present state has a high value.

The wait time T₂ sets a frequency of polling of the present state by the system 5. Its value is a compromise between the need to limit the traffic between the system 5 and the network 3 and the need for the application server to be rapidly informed of a mobile subscriber who is leaving the present state.

The lifetime T₃ of the invisible SMSs sent by the system 5 in the present state has a low value, a present mobile subscriber being supposed to send an acknowledgement of receipt rapidly. Since there is a latency resulting from the wait time T₂, it is advisable to choose a lifetime T₃ less than the wait time T₂.

The system 5 comprising first and second technical means for extracting from the mobile telecommunication core network the state of presence of a subscriber, the system 5 finally comprises third means for communicating the extracted state to the application server 7, 8. These means comprise, for example, a protocol interface for transmitting the presence information over the network 6 to the application server. The application server must itself have the dual protocol interface with the system 5 to make best use of the presence information.

A short message intended for the mobile subscriber as a distinctive signal sent to the network 3 has the advantage of being easy to implement.

However, it is not the only possible distinctive signal.

For example, the ATI (Any Time Interrogation) procedure makes it possible to send, as a distinctive signal, an interrogation of the HLR (Home Location Register), the reaction of the network 3 then being a response from the HLR which gives the latest known state of the mobile subscriber according to the 3GPP Recommendation TS 29.002, more particularly its paragraph 21.2.7. It should be noted that the information thus recovered is not necessarily up-to-date.

As a further example, the ATM (Any Time Modification) procedure defined in the 3GPP Recommendation TS 29.002, more particularly in paragraphs 24A.2 and 8.1.8, makes it possible to set a CAMEL (Customized Applications for Mobile network Enhanced Logic) detection point on any modification of state of a mobile subscriber. The VLR (Visitor Location Register) managing the subscriber then notifies the system 5 of presence detection which acts as a CSE according to the CAMEL naming scheme, on each change of state.

Irrespective of the technique of extracting presence from the mobile communication network, the application servers of the IP world keep a single interface with the mobile communication network, that is the system 5 which lists the presence and non-presence states of the communication mobiles, thus making deployment easier.

Whether the distinctive signal is of the periodic transmission type as is the case of the invisible SMSs or of the ATI procedure or is of the updating subscription type as is the case of the ATM procedure, the system 5, by centralizing the presence information relating to the mobile subscribers, provides a cache function for the application servers. Thus, the system 5 prevents unnecessarily acting on the mobile communication network when several application servers need to access the presence information.

1. A method for informing an application server whether or not a mobile subscriber is present on a mobile telecommunication network, the method comprising:
a first step for sending a first distinctive signal from the mobile subscriber to the mobile telecommunication network, intended for the mobile subscriber;
a second step for determining a present or not present binary state according to a reaction of the mobile telecommunication network to said first signal; and
a third step for communicating to the application server the state determined in the second step.

2. The method of claim 1, wherein said first signal is a short message sent to the mobile telecommunication network intended for the mobile subscriber; the method further comprising:
a first transition enabled by a reaction of the mobile telecommunication network indicating that the message is delivered, respectively a second transition enabled by an expiry of a time delay without reaction from the mobile telecommunication network, activates the second step that determines the present, respectively not present state of the mobile subscriber.

3. The method of claim 2, further comprising:
positioning a data coding scheme parameter in a header of the short message at a value that has the effect of commanding the mobile receiving the message to discard the content of the message and to deactivate a message received indication on the mobile.

4. The method of claim 2, wherein the first step is activated during an activation of the second step by positioning a time delay that is a function of the present or not present state determined in the second step.

5. The method of claim 4, further comprising:
a step of a wait time activated when the second step determines the present state so as to activate the first step after expiry of the wait time.

6. The method of claim 1, wherein:
said first signal consists of a telecommunication network node interrogation of the present or not present state of the mobile subscriber; and
the reaction of the mobile telecommunication network includes a response of the telecommunication network node on the present or not present state of the mobile subscriber.

7. The method of claim 1, wherein:
said first signal consists of a positioning of a detection point on a telecommunication network node relating to any modification of the present or not present state of the mobile subscriber; and
the reaction of the mobile telecommunication network includes a notification of the telecommunication network node relating to each modification of the present or not present state of the mobile subscriber.

8. The method of claim 1, wherein an activation of the third step communicating the present state to the application server is followed by an activation of the third step communicating the not present state to the application server when the state determined in the second step passes from present to not present.

9. The method of claim 1, wherein an activation of the third step results from a transition enabled by a request originating from the server to request the state of the mobile subscriber.

10. A system for informing an application server whether or not a mobile subscriber is present on a mobile telecommunication network, comprising:
first means for sending a first distinctive signal from the mobile subscriber to the mobile telecommunication network, intended for the mobile subscriber;
second means for determining a present or not present binary state according to a reaction of the mobile telecommunication network to said first signal; and
third means for communicating to the application server the state determined by the second means.

11. The system of claim 10, wherein:
the first means is arranged to send the first signal in the form of a short message intended for the mobile subscriber; and
the second means is arranged to determine the present state when the short message is delivered and to determine the not present state when the short message is not delivered after expiry of a preset time delay.

12. The system of claim 11, wherein the first means is arranged to send said first signal at regular time intervals that depend on the present or not present state of the mobile subscriber.

13. A computer program product residing on a computer readable medium having a plurality of instructions stored thereon which, when executed by the processor cause that processor to perform the method of claim 1.
